(19) United States
(12) Patent Application Publication
(10) Pub. No.: US 2014/0270753 A1
(43) Pub. Date: Sep. 18, 2014

(54) METHOD AND SYSTEM FOR COMMUNICATING WITH REMOTE EQUIPMENT

(71) Applicant: Vincent Loredo, Richardson, TX (US)

(72) Inventor: Vincent Loredo, Richardson, TX (US)

(73) Assignee: TELLABS OPERATIONS, INC., Naperville, IL (US)

(21) Appl. No.: 13/800,538

(22) Filed: Mar. 13, 2013

(51) Int. Cl. H04B 10/07

(52) U.S. Cl. CPC H04B 10/07
USPC 398/25

(57) ABSTRACT

An embodiment of the invention comprises a testing device selecting at least one power port for testing. The testing device enables at least one power port to output power, where the power may be used by a corresponding remote device that may be present. The testing device may then determine whether a corresponding remote device may be communicatively coupled to it. After the determination, the power port may be disabled from outputting power.

### BACKGROUND

### Field

Example aspects described herein relate generally to communications equipment, and more specifically to method and system for communicating with remote equipment.

At times it may be desirable to inventory equipment in a network. This may be to keep track of the equipment and/or to ensure that correct services are provided to that equipment by the service provider. In a traditional Passive Optical Network (PON), for example, many individual point to point copper cable connections are replaced with a single lightweight fiber optic cable that can use localized optical splitters to distribute the network signals to each user location from a single fiber drop. The point-to-multi-point nature of the PON solution reduces space requirements and cost, but eliminates the one-to-one relationship between the network switch port and the end user's location.

### SUMMARY

Existing limitations associated with the foregoing, and other limitations, can be overcome by procedures, apparatuses, computer programs, and networks, according to example aspects described herein.

Methods and systems for communicating with remote equipment are described. One example embodiment may comprise a testing device selecting at least one power port for testing. The testing device may enable at least one power port to output power. The testing device may then determine whether it is communicatively coupled to a remote device that may correspond to the power port that is outputting power. After the determination, the power port may be disabled from outputting power.

Another example embodiment may comprise a testing device configured to be able to select one or more power ports for testing, and one or more remote devices, at least one of which corresponds to each of the one or more power ports. The testing device may be configured to be able to enable at least one of the power ports to output power. The testing device may also be configured to be able to determine whether there may be a functional corresponding remote device communicatively coupled to the testing device. The testing device may be configured to be able to disable at least one of the power ports from outputting power to the corresponding remote device upon determining whether the testing device is communicatively coupled to a corresponding remote device.

A further example embodiment may comprise a machine-readable storage having stored thereon a computer program having at least one code section executable by a machine for causing the machine to perform steps comprising selection of one or more power ports for testing, enabling at least one of the power ports to output power, determining whether a corresponding remote device is communicatively coupled to the testing device; and disabling at least one of the power ports from outputting power after the determination.

### BRIEF DESCRIPTION OF THE DRAWINGS

The teachings claimed and/or described are further described in terms of exemplary embodiments. These exemplary embodiments are described in detail with reference to the drawings. These embodiments are non-limiting exemplary embodiments in which like reference numerals represent similar structures throughout the several views of the drawings, and wherein:

FIG. 1 is an exemplary diagram illustrating communication between equipment at a service provider and equipment at a customer site that may be used in an embodiment of the invention.

FIG. 2 is an exemplary diagram illustrating communication between an upstream device and downstream devices in accordance with an embodiment of the invention.

FIGS. 3a and 3b are exemplary diagrams illustrating an upstream device communicating with downstream devices to gather information regarding the downstream devices in accordance with an embodiment of the invention.

FIGS. 4a and 4b are exemplary diagrams illustrating an upstream device communicating with downstream devices to detect an unauthorized downstream device in accordance with an embodiment of the invention.

FIGS. 5a and 5b are exemplary flow diagrams illustrating communication between upstream devices and downstream devices in accordance with an embodiment of the invention.

FIG. 6 is another exemplary flow diagram illustrating communication between upstream devices and downstream devices in accordance with an embodiment of the invention.

FIG. 7 is an exemplary flow diagram for handling timeouts in accordance with an embodiment of the invention.

### DETAILED DESCRIPTION

Various example embodiments of a method and system for communicating with remote equipment will be described with respect to FIGS. 1 to 7.

FIG. 1 is an exemplary diagram illustrating communication between equipment at a service provider and equipment at a customer site that may be used in an embodiment of the invention. FIG. 1 shows optical line terminal (OLT) 101 and element management system (EMS) 102 at the service provider (SP) 100. There is also shown optical network terminal (ONT) 111 at a customer premise (CP) 100. The OLT 101 communicates with the EMS 102, where the EMS 102 may be used to control the OLT 101 and read status from the OLT 101. The OLT 101 may be used to provide various services to a customer via the ONT 111. The services may comprise, for example, internet service, phone service, and video service. Particular services provided to the customer at the CP 110 may vary depending on the services that the customer signed up for.

FIG. 2 is an exemplary diagram illustrating communication between an upstream device and downstream devices in accordance with an embodiment of the invention. FIG. 2 shows an OLT 200, an EMS 210, a plurality of managed power hubs (MPHs) 220a . . . 220b, and a plurality of ONTs 230a . . . 230d. The OLT 200 and EMS 210 operate similarly as the OLT 101 and EMS 102 in FIG. 1. The ONTs 230a . . . 230d operate similarly as the ONT 111 in FIG. 1.

The OLT 200 may comprise a processor 200a and storage medium 200b. The processor 200a may execute code stored in the storage medium 200b to control various operations of the OLT 200, including controlling the MPHs 220a . . . 220b. The processor 200a may also execute code stored in the storage medium 200b to communicate with the EMS 210 and the ONTs 230a . . . 230d.

Each of the MPHs 220a . . . 220b may operate to provide power to a plurality of ONTs. For example, the MPH 220b is shown to provide power to the plurality of ONTs 230a . . . 230d. Power to an ONT may be provided via a power port on a MPH. In FIG. 2, the power ports 220-1, 220-2, 220-3, and 220-4 may be used to provide power from the MPH 220b to the ONTs 230a, 230b, 230c, and 230d.

In an embodiment of the invention, power may be provided to the ONTs based on commands from the OLT 200. For example, the OLT 200 may send one or more commands to the MPH 220b so that the power ports 220-1, 220-2, and 220-4 are enabled to output power while the power port 220-3 is disabled from outputting power. In this manner, power may be provided to the ONTs 230a, 230b, and 230d, but not to the ONT 230c. Power may not be provided by the power port 220-3 because there may not be an ONT associated with the power port 220-3, or if there is an ONT associated with the power port 220-3, it may have been determined that the ONT associated with the power port 220-3 should not have power delivered to it. This will be explained further below.

While the MPHs 220a . . . 220b may be placed geographically near the ONTs 230a . . . 230d, and accordingly may be considered to be part of the CP 110 in FIG. 1. However, the actual placement of the MPHs 220a . . . 220b is design, implementation, and/or network dependent, and accordingly whether the MPHs 220a . . . 220b are considered to be a part of the CP 110 or the SP 110 may change.

FIGS. 3a and 3b are exemplary diagrams illustrating an upstream device communicating with downstream devices to gather information regarding the downstream devices in accordance with an embodiment of the invention. FIGS. 3a and 3b show an embodiment of the invention using the same devices and configuration described in FIG. 2. In this embodiment, a commercial network 300 is presumed where the MPH 220b and the ONTs 230a . . . 230d are in the same general location such as, for example, a single building.

To prevent an ONT from being relocated, a power port at the MPH 220b can be programmed to not supply power to an ONT if that ONT's serial number, as an example, is not the same one that power port was originally associated with. Since it may be presumed in this hypothetical case that the ONTs and the MPH are both connected to backup power and the ONTs will not be moved much, an inventory sequence may occur on demand. However, an embodiment of the invention need not be so limited. In various embodiments of the invention, the inventory sequence may be scheduled to occur periodically where the schedule may be variable by the network operator, or may be automatically triggered by certain circumstances. One of these circumstances may be, for example, when primary power is disrupted and backup power is used. The on-demand and scheduling options may also be available when the ONTs and the MPH are not connected to backup power.

The EMS 210 may be configured to remotely administer the power ports 220-1 . . . 220-4 on the MPH 220b in the network 300. The MPH 220b may have the capability to enable and disable power output of each one of the power ports 220-1 . . . 220-4 associated with each one of the remotely powered ONTs 230a . . . 230d and communicate with the EMS 210 via in-band or out of band signaling using any available protocol associated with the network in use. The EMS 210 may also comprise an inventory database 210a.

As shown in FIG. 3a, when an inventory sequence is initiated, all of the power ports 220-1 . . . 220-4 on the MPH 220 may be disabled from providing output power. Accordingly, since none of the ONTs 230a . . . 230d connected to the power ports 220-1 . . . 220-4, respectively, have power, they are deactivated. The network element inventory database 210a associated with the MPH 220b is cleared, including any provisioned ONT serial numbers. The first power port 220-1 on the MPH 220b is enabled to output power to the ONT 230a. Upon receipt of power, the ONT 230a may power up and attempt to connect, or communicate, to the OLT 200.

When the OLT 200 establishes connection, or communication, with the ONT 230a, it enables the ONT 230a, and adds an ONT identifier such as, for example, the serial number sent by the ONT 230a, and the associated power port and/or cable information, to the inventory database 210a. In an embodiment of the invention, for the purposes of inventorying power output may be disabled for the present power port 220-1, and the next power port 220-2 is enabled to output power. This procedure is repeated for all of the power ports 220-1 . . . 220-4. In this manner, each of the power ports 220-1 . . . 220-4 may be checked to see if there is a corresponding functional ONT connected to each power port. Various embodiments may allow a plurality of power ports to output power to their corresponding ONTs.

Various embodiments of the invention may allow the inventory sequence to sequentially occur for all MPHs connected to an OLT, for example, MPHs 220a . . . 220b connected to the OLT 200, or for a subset of the MPHs connected to an OLT. Additionally, while an embodiment of the invention is described where power output by a power port is disabled after testing that power port to see if communication with a corresponding ONT is present, an embodiment of the invention need not be so limited. For example, various embodiments of the invention may enable the power port 220-1 to keep outputting power if it is determined that there is communication between the OLT 200 and the ONT 230a corresponding to the power port 220-1. The power port 220-2 may then be tested. Accordingly, some embodiments of the invention may disable output power after testing a power port if an OLT is not able to communicate with the corresponding ONT. Various embodiments of the invention may also allow an option where the output power of a power port may be enabled or disabled depending on a testing result of that power port.

The communication path between the ONTs and the OLT may be design and/or implementation dependent. For example, the communication path may be from the OLT 200 to the ONTs 230a . . . 230d via the MPH 220b, or the communication path may be directly from the OLT 200 to the ONTs 230a . . . 230d.

As shown in FIG. 3b, if testing of any of the power ports 220-1 . . . 220-4 results in a corresponding ONT failing to connect to the OLT 200 during a timeout interval, that ONT may be skipped, and the process may continue with the remaining power ports. For example, when the connection by an ONT times out for the power port 220-3, the OLT 200 may continue by removing power from the power port 220-3 and providing power to the power port 220-4. The inventory database 210a may be updated to indicate there is no ONT associated with the power port 220-3 of the MPH 220b. The timeout for the power port 220-3 may occur, for example, because there is no ONT connected to that power port, or an ONT may be defective, or the power cable and/or signal cable to the ONT may be defective or not connected correctly.

Various embodiments of the invention may allow repeating the connection process for the timed-out power port, where the timeout period and/or the number of retries may be variable by, for example, the network operator. The number of retries and the timeout period for each power port may also be kept, for example, in the inventory list stored in the inventory database 210a. Additionally, while the OLT 200 has been described as running the inventory sequence, that functionality may be provided by other elements in the network 300, such as, for example, the MPH 220 and/or the EMS 210.

FIGS. 4a and 4b are exemplary diagrams illustrating an upstream device communicating with downstream devices to detect an unauthorized downstream device in accordance with an embodiment of the invention. FIG. 4a shows the OLT 200, the EMS 210, a plurality of ONTs 230a . . . 230d, and the MPH 420. FIG. 4a also shows a port selector 410. The port selector 410 may be used to select one or more power ports where attempts can be made to communicate with specific ONTs rather than attempting to communicate with all ONTs that may be connected to all power ports of one or more MPHs. This may be, for example, for adding an ONT to a PON network. Various embodiments of the invention may allow the selected power ports to be on the same MPH, while others may allow the selected power ports to be spread out over a plurality of MPHs. It may also be noted that the port selector 410 is shown as a separate device in FIGS. 4a and 4b. However, an embodiment of the invention need not be so limited. For example, in various embodiments of the invention the port selector 410 may be part of the OLT 200, EMS 210, and/or the MPH 220b.

If an ONT fails to identify during the inventory sequence described with respect to FIGS. 3a and 3b, a specific inventory sequence may be run for those power ports that do not have enabled ONTs associated with them. The power ports to select for inventory sequence may be identified by querying, for example, the inventory database 210a. Other embodiments of the invention may allow identification of a power port with no associated ONT with a signal, such as, for example, a blinking LED that indicates the position of the power port on the front panel of the MPH or a signal near a connector to which a cable may be provisioned to an ONT. The new ONT can be attached to the cable identified by the signal. Accordingly, the ONT can be powered, enabled, associated with its new power port and cable, and appropriate data entered in the inventory database 210a.

If the power port location is not convenient, or not functional, the installation technician can skip that power port by pressing, for example, an increment or decrement button on the port selector 410, or by using a software application that may interface with the port selector 410. Accordingly, the technician can add or replace an ONT on any unused power port. This process may also be used to update the inventory database when an ONT is removed from a power port if that ONT is no longer needed.

FIG. 4a shows ONTs 430a, 430b, and 430c connected to power ports 220-1, 220-1, and 220-3, respectively. As shown in FIG. 4b, the ONT 430c has been moved to a cable that it was not authorized for. In this example, the ONT 430c has been moved from power port 220-3 to power port 220-4. Accordingly, after the ONT 430c is provided power to be able to communicate with it, it is determined that the ONT 430c is associated with a wrong power port. Since the serial number of the ONT 430c is not the same as the one that was previously associated with the power port 230-4, power to the power port 230-4 can be removed. Similarly, because there is no communication with the ONT 430c that was connected to the power port 220-3, power to the power port 220-3 may be removed. An alarm may also be raised by, for example, the EMS 210 upon detection of an unauthorized ONT. The alarm may be sent to, for example, the network operator.

FIGS. 5a and 5b are exemplary flow diagrams illustrating communication between upstream devices and downstream devices in accordance with an embodiment of the invention. In FIG. 5a, box 510 indicates that inventory process starts. Box 520 indicates that a specific power port, for example, the power port 220-1 is selected by a testing device such as, for example, the OLT 200. The OLT 200 may send a command to the MPH 220b to enable the power port 220-1 to output power, and thereby provide power to a remote device such as, for example, an ONT connected to the power port 220-1. Box 530 indicates that communication is desired with an ONT that may be connected to the specific power port. In a Passive Optical Network for example, this may comprise the ONT 230a powering up and attempting to communicate with the OLT 200. If within a certain timeout period after power is enabled by the power port 220-1 there is no communication between the OLT 200 and the ONT 230a, then the inventory process proceeds to box 560 where output power is turned off by the power port 220-1.

If there is communication, then box 550 indicates that ONT information, such as, for example, the ONT serial number, is collected by the OLT 200. Proceeding to the next box 560, output power of the power port 220-1 is turned off. In box 570, a check is made to see if all of the power ports for this inventory sequence have been checked. If so, then information may be forwarded on to, for example, the EMS 210, as shown in box 580. Otherwise, the process proceeds to selecting the next power port, as shown in box 520.

While the collected information is described as being sent after all of the power ports have been checked, an embodiment of the invention need not be so limited. In various embodiments of the invention the information may be sent, for example, for each power port under test. Furthermore, the power ports selection may be automatic selection of all available power ports or may be selection of a subset of the available power ports. Selecting a subset of the available power ports may be done using, for example, the port selector 410.

FIG. 5b is substantially similar to FIG. 5a except that upon collecting ONT information as shown in box 550, rather than disable output power of the power port under test (for example, the power port 220-1), the output power is left enabled so that the corresponding ONT (for example, the ONT 230a) is still capable of communicating with the OLT 200. The process may then proceed to box 570, and appropriate functions may take place as described with respect to FIG. 5a.

FIG. 6 is another exemplary flow diagram illustrating communication between upstream devices and downstream devices in accordance with an embodiment of the invention. Box 610 indicates that inventory process starts. Box 620 indicates that the testing device such as the OLT 200, for example, may select a specific power port such as the power port 220-1, for example, to test. A technician may have input the selection for the power port 220-1 via, for example, the port selector 410, and this selection may be communicated to the OLT 200. The selected power port 220-1 is then enabled to output power.

Box 640 indicates that communication is desired with a remote device, for example, the ONT 230a, that may be connected to the power port 220-1 being tested. The ONT 230a information such as, for example, the serial number, is collected and sent to, for example, the EMS 210.

FIG. 6 is described with only one power port being selected. However, an embodiment of the invention need not be so limited. In various embodiments of the invention a plurality of power ports may be selected for inventorying. Accordingly, the inventory sequence may be as described with respect to FIG. 5 for multiple power ports, or the inventory sequence may follow the simpler format described with respect to FIG. 6. The inventory sequence may vary depending on design and/or implementation, and may comprise a variety of methods.

FIG. 7 is an exemplary flow diagram for handling timeouts in accordance with an embodiment of the invention. In FIG. 7 there is shown another method of handling timeouts as described with respect to FIGS. 5a and 5b. FIG. 7 is an expansion of box 540 in FIGS. 5a and 5b.

It can be seen in box 700 that a timeout counter is cleared. In box 710, if communication was established between a downstream device for a power port (for example, the ONT230a for the power port 220-1) and an upstream device (for example, the OLT 200) before a timeout, then the process continues with box 550. However, if there was a timeout before communication was established, then box 720 indicates that a check is made to see if the number of timeouts corresponding to the power port 220-1 has reached a threshold, which may be variably set to one or more.

If the number of timeouts has reached the threshold, then no more attempts are made to establish communication between the OLT 200 and the ONT 230a. The process then proceeds to box 560. If the threshold has not been reached, then the number of timeouts is incremented and there is further wait to establish communication.

While various assumptions have been made in describing various embodiments of the invention for ease of explanation, it should be noted that the invention is not limited to any specific implementations described with respect to FIGS. 1-7. The specification and drawings are accordingly to be regarded in an illustrative rather than in a restrictive sense. It will, however, be evident that various modifications and changes may be made thereto without departing from the broader spirit and scope of the present invention.

In addition, it should be understood that the figures illustrated in the attachments, which highlight the functionality and advantages of the present invention, are presented for example purposes only. The architecture of the example aspect of the present invention is sufficiently flexible and configurable, such that it may be utilized (and navigated) in ways other than that shown in the accompanying figures. For example, descriptions of various figures have been made where power is provided to one power port at a time for the ease of description. However, an embodiment of the invention need not be so limited. For example, in various embodiments of the invention the EMS 210 may communicate to multiple testing devices, where each testing device may communicate in parallel with one remote device at a time. Additionally, a testing device may also communicate with a plurality of remote devices where communication from each remote device may be distinguished by specific information unique to that remote device such as, for example, a serial number. Furthermore, while embodiments of the invention have been described as relating to a passive optical network (PON) comprising OLTs and ONTs, various embodiments of the invention may be used for networks other than PONS where one upstream testing device may control a plurality of downstream remote devices and an inventory of the downstream remote devices is desired.

Although example aspects of this invention have been described in certain specific embodiments, many additional modifications and variations would be apparent to those skilled in the art. It is therefore to be understood that this invention may be practiced otherwise than as specifically described. Thus, the present example embodiments should be considered in all respects as illustrative and not restrictive. For example, while software is used to describe instructions and/or data that may be used by a processor or a controller for executing certain functions, the term “software” also includes firmware and any other machine executable instructions stored on any machine readable storage medium. A “machine” may be a computer, processor, controller, etc. configured to read and execute software.

What is claimed:

1. A method comprising:
selecting by a testing device one or more power ports for testing;
enabling by the testing device at least one of the power ports to output power;
determining whether a corresponding remote device is communicatively coupled to the testing device; and
disabling the at least one of the power ports from outputting power after the determining.

2. The method of claim 1 wherein it is determined that the testing device is communicatively coupled to the corresponding remote device when the testing device receives information from the corresponding remote device within a timeout period.

3. The method of claim 2 wherein the timeout period is variable.

4. The method of claim 2 comprising storing the received information in a database.

5. The method of claim 2 wherein at least the received information is used to inventory the one or more power ports and the communicatively coupled corresponding remote devices.

6. The method of claim 1 comprising, if the one or more power ports is a plurality of power ports, sequentially enabling each of the plurality of power ports to output power.

7. The method of claim 6, wherein output power for a present power port is disabled before enabling output power for a next power port.

8. The method of claim 1, wherein output power is disabled for the at least one of the power ports only in response to determining that the corresponding remote device is not communicatively coupled to the testing device.

9. The method of claim 1 wherein the testing device is an optical line terminal.

10. The method of claim 1 wherein the corresponding remote device is an optical network terminal.

11. The method of claim 1 wherein the one or more power ports receives commands from an optical line terminal to enable power output or disable power output.

12. A system comprising:
a testing device configurable to select one or more power ports for testing; and
one or more remote devices where at least one of each corresponds to one of the power ports,
wherein the testing device is configurable to enable at least one of the power ports to output power and to disable output power, and the testing device is configurable to determine whether the corresponding remote device is communicatively coupled to the testing device.

13. The system of claim 12 wherein it is determined that the testing device is communicative coupled to the corresponding remote device when the testing device receives information from the corresponding remote device within a timeout period.

14. The system of claim 13 wherein the timeout period is variable.

15. The system of claim 14 comprising storing the received information in a database.

16. The system of claim 14 wherein at least the received information is used to inventory the one or more power ports and the communicatively coupled corresponding remote devices.

17. The system of claim 12 wherein, if the one or more power ports is a plurality of power ports, each of the plurality of power ports is sequentially enabled to output power.

18. The system of claim 17, wherein output power for a present power port is disabled before enabling output power for a next power port.

19. The system of claim 12, wherein output power is disabled for the at least one of the power ports only in response to determining that the corresponding remote device is not communicatively coupled to the testing device.

20. The system of claim 12 wherein the testing device is an optical line terminal.

21. The system of claim 12 wherein the corresponding remote device is an optical network terminal.

22. The system of claim 12 wherein the one or more power ports receives commands from an optical line terminal to enable power output or disable power output.

23. A machine-readable storage having stored thereon a computer program having at least one code section executable by a machine for causing the machine to perform steps comprising:
selecting one or more power ports for testing;
enabling at least one of the power ports to output power;
determining whether a corresponding remote device is communicatively coupled to the testing device; and
disabling the at least one of the power ports from outputting power after the determining.

24. The machine-readable storage of claim 23 comprising code to enable determination that the testing device is communicatively coupled to the corresponding remote device when the testing device receives information from the corresponding remote device within a timeout period.

25. The machine-readable storage of claim 24 comprising code to allow changing of the timeout period.

26. The machine-readable storage of claim 24 comprising code to communicate the received information for storing in a database.

27. The machine-readable storage of claim 24 wherein at least the received information is used to inventory the one or more power ports and the communicatively coupled corresponding remote devices.

28. The machine-readable storage of claim 23 comprising code to allow, if the one or more power ports is a plurality of power ports, sequentially enabling each of the plurality of power ports to output power.

29. The machine-readable storage of claim 28 comprising code to allow disabling output of power for a present power port before enabling output of power for a next power port.

30. The machine-readable storage of claim 23 comprising code to disable output of power for the at least one of the power ports only in response to determining that the corresponding remote device is not communicatively coupled to the testing device.
